(19) United States
(12) Patent Application Publication
(10) Pub. No.: US 2017/0252762 A1
(43) Pub. Date: Sep. 7, 2017

(54) No Pump Sprayer

(71) Applicant: Jay S. Derman, Temecula, CA (US)

(72) Inventor: Jay S. Derman, Temecula, CA (US)

(21) Appl. No.: 15/096,271

(22) Filed: Apr. 11, 2016

Related U.S. Application Data
(60) Provisional application No. 62/301,682, filed on Mar. 1, 2016.

(51) Int. Cl. B05B 7/24; F16K 17/02; B05B 7/12

(52) U.S. Cl. CPC B05B 7/2491; B05B 7/12; F16K 17/02

(57) ABSTRACT

The present lid and sprayer provides a safe and labor-saving means to pressurize the interior of a pressure vessel through the use of a valve stem. The valve stem extends from the top of the lid, aligned with the cylindrical axis of the lid and protected from damaging impact. The valve stem may be protected by the gripping portion of the lid and may be protected by other enclosing structures within the lid. The user partially fills the pressure vessel, and attached the present lid. Then, the air chuck of a compressor is attached to the valve stem to pressurize the pressure vessel. Thus, the user may spray a liquid from the sprayer without the need for manual pumping.

### RELATED APPLICATION DATA

This application claims the priority date of provisional application No. 62/301,682 filed on Mar. 1, 2016, which is herein incorporated by reference in its entirety.

### BACKGROUND

Manual pump sprayers are used at home and in industry for spraying liquids such as insecticides, pesticides, herbicides, fertilizers, water, and other sprayable liquids. The user generally partially fills the sprayer container with liquid, leaving space at the top for air. Then, the user manually pumps the sprayer by moving a pump piston up and down to compress the air within the container. The manual pump has moving parts which increase the cost of manufacturing and increases the workload on the user. Further, the manual pumps extend to just above the bottom of the sprayer container, submerging much of the pump in the contained liquid. As the user repeatedly actuates the manual pump to pressurize the container, the liquid is introduced to the interior of the manual pump dip tube to cause contamination and unwanted bubbles may be produced within the liquid.

Valve stems which connect to compressor chucks have been inserted through the wall of the container. The placement of the valve stem through the container wall increases manufacturing complexity and potentially weakens the integrity of the container. Further, because the sprayer is often used under rough conditions, with much jostling and abuse, an exposed valve stem extending from the container wall is in danger of being damaged or snapped off.

### SUMMARY

The present support device provides a sprayer for dispensing a liquid under pressure, without requiring manual pumping and without the drawbacks of current sprayer systems, such as cross-contamination, unwanted bubbling in the liquid, and valve stems exposed to external impacts.

The sprayer generally includes a pressure vessel, a lid with a valve stem, and a spray nozzle. The pressure vessel has an outer wall, a bottom wall, an interior defined by the outer wall and the bottom wall, and an opening opposite the bottom wall for pouring liquids through. The lid attaches to the opening of the pressure vessel; the lid has a valve stem extending from a top portion and is configured to receive a chuck of a compressor; the lid has an attachment portion for attaching the lid to the opening. The spray nozzle is located at a terminus of a hose that is connected through the outer wall to a siphon within the interior. The liquid is poured through the opening to partially fill the interior of the pressure vessel; and the lid is attached to the opening to hermetically seal the lid to the opening. The compressor chuck is connected to the valve stem and pressurized gas is introduced through the valve stem to pressurize the interior. Opening the spray nozzle permits the liquid to be forced out of the interior under pressure through the siphon dipping in the liquid.

Optionally, the opening can be threaded and the attachment portion of the lid is threaded, so that the lid threads to the opening to attach the lid to the opening, the valve stem extending through a center of the lid along a cylindrical axis of the lid. An inner pocket may be defined in the lid by a top wall and an outer circumferential wall; a through hole is formed through the top wall; the valve stem is fitted in the through hole, with a valve rib gripping the top wall. The lid may further comprise a gripping portion for manually turning the lid, the valve stem positioned beneath the gripping portion. A recess may be formed in the top portion opposite the inner pocket, with the top wall dividing the recess and the inner pocket. The valve stem may be positioned substantially beneath a top rim of the recess.

A lid is provided with a valve stem extending from a top portion and configured to receive an air chuck of a compressor; the valve stem extending through a center of the lid along a cylindrical axis of the lid. The lid further includes a threaded engagement portion for attaching the lid to the threaded opening of the pressure vessel. An annular shoulder is provided for compressing an annular gasket against a sealing surface of the threaded opening. A gripping portion is provided for manually turning the lid, with the valve stem being protectively positioned beneath the gripping portion. The liquid is poured through the threaded opening to partially fill the interior of the pressure vessel; and the lid is attached to the threaded opening to hermetically seal the lid to the threaded opening by compression of the annular gasket. The chuck of the compressor is connected to the valve stem and pressurized gas is introduced through the valve stem from the compressor to pressurize the interior. The spray nozzle permits the liquid to be forced out of the interior under pressure through the siphon.

Optionally, an inner pocket may defined in the lid by a top wall and an outer circumferential wall, a through hole is formed through the top wall, the valve stem is fitted in the through hole, with a valve rib gripping the top wall. A recess may be formed in the top portion opposite the inner pocket, with the top wall dividing the recess and the inner pocket. The valve stem is positioned substantially beneath a top rim of the recess.

### BRIEF DESCRIPTION OF THE SEVERAL VIEWS OF THE DRAWINGS

FIG. 1 is a top view of an embodiment of the present lid;

FIG. 2 is a cross-sectional view of the embodiment of FIG. 1, taken along 2-2;

FIG. 3 is a top view of an embodiment of the present lid;

FIG. 4 is a cross-sectional view of the embodiment of FIG. 3, taken along 4-4;

FIG. 5 is a top view of an embodiment of the present lid;

FIG. 6 is a cross-sectional view of the embodiment of FIG. 5, taken along 6-6;

FIG. 7 is a broken away cross-sectional side view of the lid attached to an example embodiment of the sprayer, and showing an example compressor;

FIG. 8 is a partial magnified view of the embodiment of FIG. 7; and

FIG. 9 is a side view of the present sprayer.

### LISTING OF REFERENCE NUMERALS of FIRST-PREFERRED EMBODIMENT

| | |
|---|---|
| lid | 20 |
| valve stem | 22 |
| valve rib | 24 |
| cap | 26 |
| bottom side | 28 |
| attachment portion | 30 |
| top side | 31 |
| threads | 32 |
| annular shoulder | 34 |
| inner pocket | 36 |
| top wall | 38 |
| center | 40 |
| cylindrical axis | 42 |
| outer circumferential wall | 44 |
| through hole | 46 |
| O-ring | 48 |
| gripping portion | 50 |
| recess | 52 |
| top rim | 56 |
| gripping protrusions | 58 |
| gripping tabs | 60 |
| loop handle | 62 |
| topmost portion | 61 |
| pressure vessel | 100 |
| threaded opening | 102 |
| sealing surface | 104 |
| outer wall | 106 |
| bottom wall | 108 |
| interior | 110 |
| spray nozzle | 112 |
| hose | 114 |
| hose fitting | 116 |
| siphon | 118 |
| funnel top | 120 |
| pressure relief valve | 122 |
| pressure relief fitting | 124 |
| compressor | 200 |
| hose | 202 |
| air chuck | 204 |
| liquid | 300 |
| compressed air | 400 |
| sprayer | 500 |

### DESCRIPTION OF THE PREFERRED EMBODIMENTS

The detailed descriptions set forth below in connection with the appended drawings are intended as a description of embodiments, and is not intended to represent the only forms in which the present securement system may be constructed and/or utilized. The descriptions set forth the structure and the sequence of steps for constructing and operating the securement system in connection with the illustrated embodiments. It is to be understood, however, that the same or equivalent structures and steps may be accomplished by different embodiments that are also intended to be encompassed within the spirit and scope of the invention.

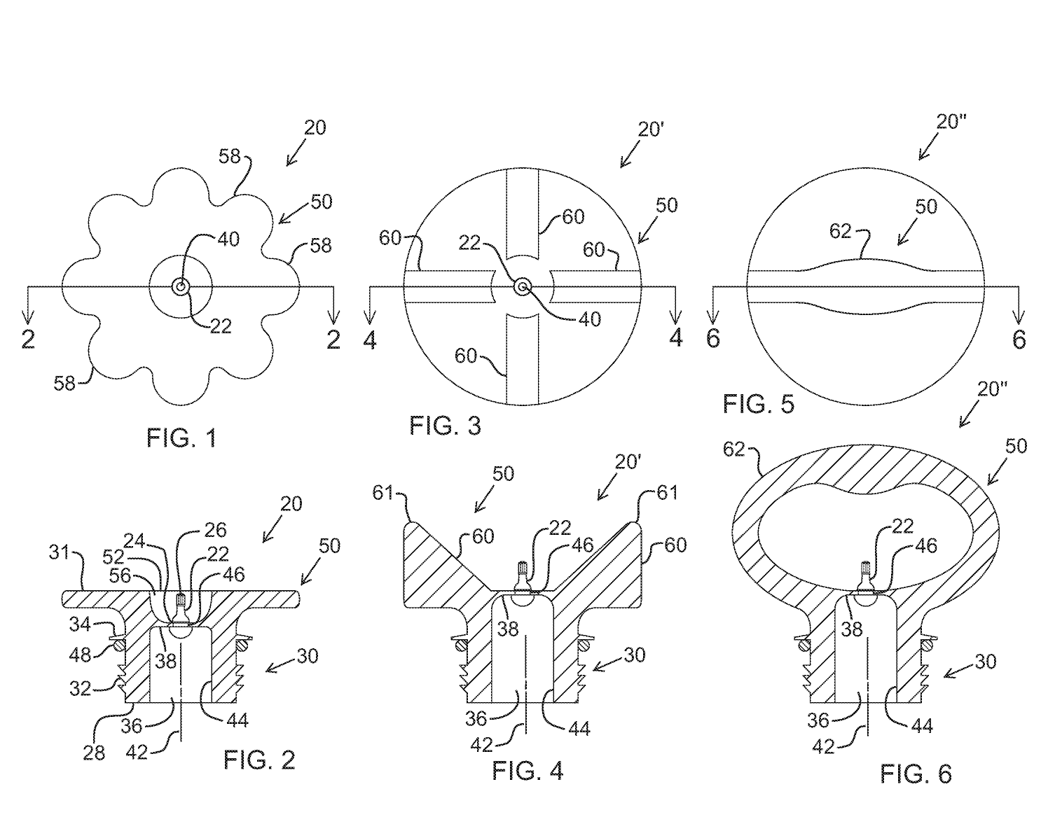

FIGS. 1-6 illustrate example embodiments of the present lid (20). The lid illustrated in FIGS. 1-2 has a gripping portion (50) about the circumference of the lid (20), which includes a plurality of radial gripping protrusions (58) so that the user may grasp the lid (20) by the palm of the hand with the fingers ergonomically positioned between the gripping protrusions (58) to permit the twisting of the lid (20) when tightening or loosening the lid (20). The lid (20) includes threads (32) on the attachment or engagement portion (30), which engage threads in the pressure vessel (100). An inner pocket (38) is formed in the bottom side (28), and is defined by an circumferential wall (44) and a top wall (38), with the threads (32) are formed on the circumferential wall (44) opposite the inner pocket (38). A recess (52) is formed on the top side (31) of the lid (20) separated from the inner pocket (38) by the top wall (38). A top rim (56) surrounds the recess (52) and defines the perimeter of the recess (52). The depth of the recess (52) is defined between top rim (56) and the top wall (38).

A through hole (46) is formed through the top wall (38), communicating between the recess (52) and the inner pocket (38). Preferably, the through hole (46) is formed at the center (40) of the lid (20) and aligned with the cylindrical axis (42) of the lid (20), which would be at the axis of rotation for threaded lids. The through hole (46) is sized to receive a standard valve stem (22), where the thickness of the top wall (38) and the through hole (46) permit the sealing of the valve rib (24) against the top wall (38) to hermetically seal the valve stem (22) to the lid (20), so that the lid (20) can seal pressurized air within the pressure vessel (100). An annular shoulder (34) encircles the lid (20) just above the threads (32). An annular seal, such as an O-ring (48), is positioned beneath the annular shoulder (34).

The valve stem (22) is preferably located within the recess (52), with the valve stem (22) located completely beneath the top rim (56). The recess (52) protects the valve stem (22) and prevents a shear or other force from dislodging or damaging the valve stem (22). Alternatively, at least part of the valve stem (22) can be located beneath the top rim (56) to prevent a shear or other force from contacting the valve stem (22) near the rib (24), where there is the least amount of flexibility in the valve stem (22) in response to the force. Even if a force were to be restricted to contacting the valve stem (22) near the cap (26), the valve stem (22) would be able to flex in response to the force and resist breakage.

A second embodiment of the present lid is illustrated in FIGS. 3-4. The valve stem (22) is attached to the lid (20′) at the through hole (46). However, in this embodiment, the valve stem (22) is not located within a recess, as shown in FIGS. 1-2. The valve stem (22) is instead protected by the gripping portion (50). Specifically, the valve stem (22) is located beneath at least a portion of the gripping portion (50) so that the valve stem (22) does not extend beyond the gripping portion (50) or other handle portion. In this example, the gripping portion (50) is comprised of a plurality of gripping tabs (60), four in this example, which allow the user to use the thumb in opposition to the fingers to push upon the gripping tabs (60) in a twisting action. The valve stem (22) is located completely or at least partially beneath the topmost portion (61) of the gripping tabs (60). Thus, the gripping tabs (60) act to protect the valve stem (22) and prevent at least some contact by damaging external forces.

Yet another example embodiment is illustrated in FIGS. 5-6. In this embodiment, the gripping portion (50) comprises a loop handle (62) which provides the user with a handle and leverage for twisting, and protects the valve stem (22). The valve stem (22) is located under the topmost portion of the loop handle (62) within the loop.

Although only the embodiment of FIGS. 1-2 show the valve stem (22) being installed within the recess (52), this embodiment can be modified with the gripping portions (50) shown in the embodiments of FIGS. 3-4 and FIGS. 5-6. In this way, the gripping protrusions (58) of FIGS. 1-2 may be eliminated and replaced with gripping tabs (60) or a loop handle.

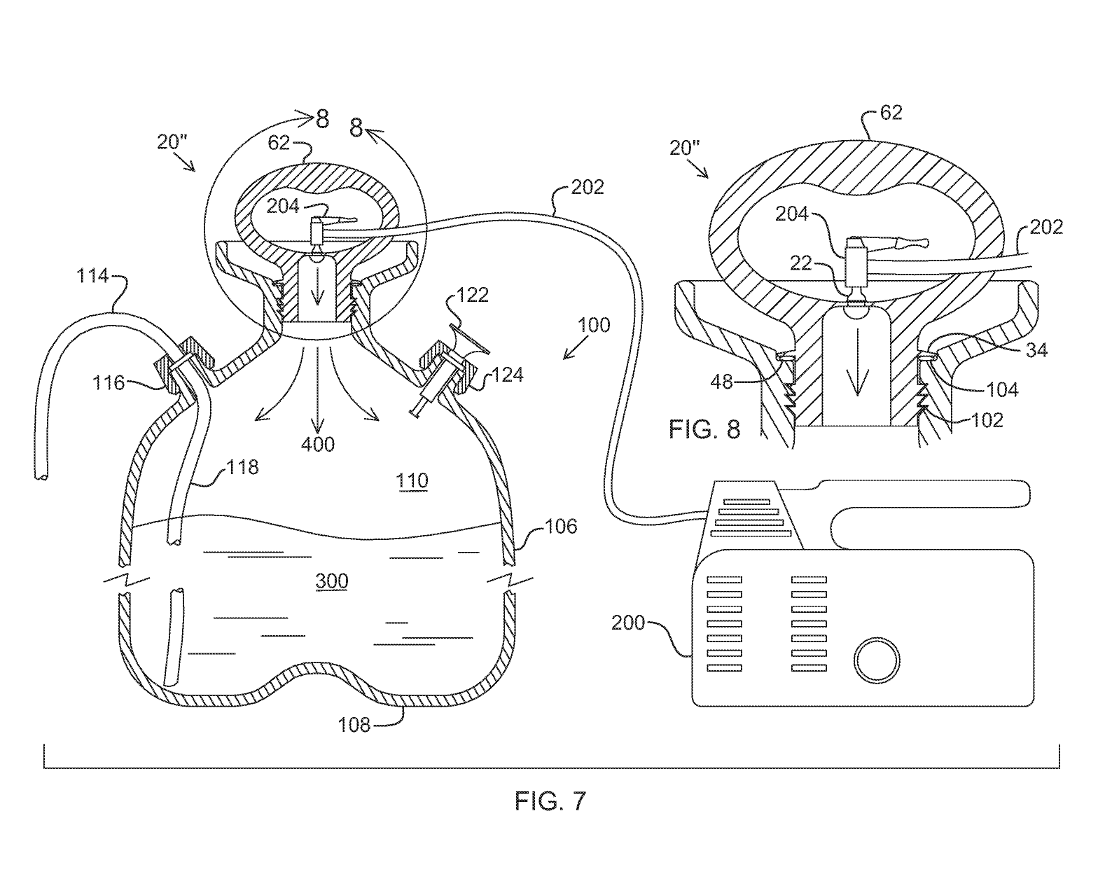

The present lid (20) is shown attached to a pressure vessel (100), in FIGS. 7-8. The pressure vessel (100) may be of many types and sizes. Most commonly, the pressure vessel (100) is made of plastic, such as a high density polyethylene, and is one to several gallons in capacity, having a funnel top (120) to guide a liquid (300) through the threaded opening (102) when the lid (20) is removed. The example sprayer (100) illustrated has a hose (114) connected through the side or outer wall (106) by a hose fitting (116). The hose (114) is either connected to or continuous with a siphon (118) extending downward in the interior (110) of the sprayer (100), down to the bottom wall (108), dipping into any contained liquid (300). A pressure relief valve (122) is connected to the sprayer (100) through the outer wall (106) with a pressure relief fitting (124).

Instead of a hand pump actuated though a lid, the present lid (20) has a valve stem (22) extending from the lid (20), preferably at least partially within a protected or sheltered partial enclosure formed in the lid (20) that prevents or reduces damaging impact. Thus, the present lid (20) does not have a manual pump in addition to the valve stem. The valve stem (20) is preferably mounted at the center (40) of the lid (20) and parallel with or aligned with the cylindrical axis (42) of the lid (20), where the circumferential wall (44) forms the reference cylinder with the cylindrical axis (42). In alternate designs, the valve stem (20) may be off-center or extended transversely to the cylindrical axis (42).

FIG. 7 shows an example pressurizing process, with an electric compressor (200) attached to the valve stem (22) by an air chuck (204), where pressurized air (400) is delivered from the compressor (200), through the hose (202), through the air chuck (204), and into the interior (110) of the pressure vessel (100). FIG. 8 is a magnified view of the lid (20) of FIG. 7, attached to the threaded opening (102) of the pressure vessel (100). The annular shoulder (34) of the lid (20) compresses the O-ring (48) against the sealing surface (104) of the threaded opening (102) to hermetically seal the lid (20) to the pressure vessel (100) so that the pressure vessel (100) may be pressurized.

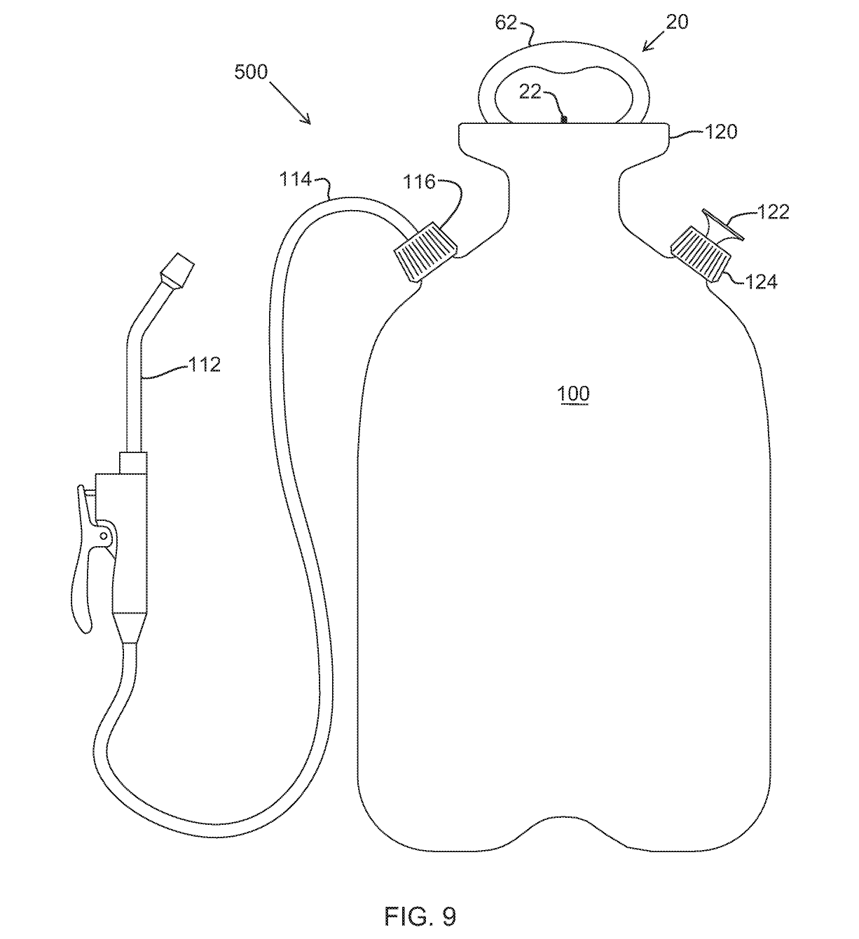

The user attaches the air chuck (204) to the valve stem (22), using a lever lock in this example, and activates the compressor (200) which delivers pressurized air (400) into the interior (110) of the pressure vessel (100) partially filled with liquid (300). Looking at FIG. 9, the lid (20) is attached to the pressure vessel (100) to form a sprayer (500). The user may carry the sprayer (500) about and direct the liquid (300) to a desired target by actuating the spray nozzle (112), permitting the liquid (300) within the interior (110) to exit the pressure vessel (100) through the spray nozzle (112) under the force of the expanding pressurized air (400).

The present lid (20) includes a valve stem (22) advantageously located at the top of the lid, which helps to substantially prevent contact with liquid (300) within the pressure vessel (100), when the pressure vessel (100) is in a mostly upright position. This feature prevents cross-contamination due to the valve stem (22) contacting multiple batches of differing liquids. This feature also prevents air from bubbling through the liquid (300) as the compressed air (400) is introduced into the pressure vessel (100), since the valve stem (22) is not near or submerged in the liquid (300). Further, the valve stem (22) is located in a protected position on the lid (20), where it is at least partially enclosed or encaged to prevent unintended external contact.

While particular forms of the present securement system have been illustrated and described, it will also be apparent to those skilled in the art that various modifications can be made without departing from the spirit and scope of the design. Accordingly, it is not intended that the invention be limited except by the claims.

1. A sprayer for dispensing a liquid under pressure and configured for compression by temporary attachment to the chuck of an external compressor, the sprayer comprising:
a pressure vessel with an outer wall, a bottom wall, an interior defined by the outer wall and the bottom wall, and an opening opposite the bottom wall for pouring liquids through;
a lid that attaches to the opening of the pressure vessel, the lid having a valve stem extending from a top portion and being configured to receive the chuck of the compressor, the lid having an attachment portion for attaching the lid to the opening with the lid being oriented so that the top portion is external to the interior of the pressure vessel with the valve stem extending outwardly from the interior of the pressure vessel; and
a spray nozzle at a terminus of a hose that is connected through the outer wall to a siphon;
wherein the liquid is poured through the opening to partially fill the interior of the pressure vessel, and the lid is attached to the opening to hermetically seal the lid to the opening;
and wherein the chuck of the compressor is connected to the valve stem and pressurized gas is introduced through the valve stem to pressurize the interior;
and wherein opening the spray nozzle permits the liquid to be forced out of the interior under pressure through the siphon.

2. The sprayer of claim 1 wherein the opening is threaded and the attachment portion of the lid is threaded so that the lid threads to the opening to attach the lid to the opening, the valve stem extending through a center of the lid along a cylindrical axis of the lid.

3. The sprayer of claim 2 wherein an inner pocket is defined in the lid by a top wall and an outer circumferential wall, a through hole is formed through the top wall, the valve stem is fitted in the through hole, with a valve rib gripping the top wall.

4. The sprayer of claim 3 wherein the lid further comprises a gripping portion for manually turning the lid, the valve stem positioned beneath the gripping portion.

5. The sprayer of claim 4 wherein a recess is formed in the top portion opposite the inner pocket, with the top wall dividing the recess and the inner pocket.

6. The sprayer of claim 5 wherein the valve stem is positioned substantially beneath a top rim of the recess.

7. A sprayer for dispensing a liquid under pressure and configured for compression by temporary attachment to the chuck of an external compressor, the sprayer comprising:
a pressure vessel with an outer wall, a bottom wall, an interior defined by the outer wall and the bottom wall, and a threaded opening opposite the bottom wall for pouring liquids through;
a lid that attaches to the opening of the pressure vessel, the lid having a valve stem extending from a top portion and configured to receive the air chuck of the compressor, the valve stem extending externally from the interior of the pressure vessel and through a center of the lid along a cylindrical axis of the lid, the lid having an threaded engagement portion for attaching the lid to the threaded opening, the lid having an annular shoulder for compressing an annular gasket against a sealing surface of the threaded opening; and
a spray nozzle at a terminus of a hose that is connected through the outer wall to a siphon;
wherein the liquid is poured through the threaded opening to partially fill the interior of the pressure vessel, and the lid is attached to the threaded opening to hermetically seal the lid to the threaded opening by compression of the annular gasket;
and wherein the chuck of the compressor is connected to the valve stem and pressurized gas is introduced through the valve stem from the compressor to pressurize the interior;
and wherein opening the spray nozzle permits the liquid to be forced out of the interior under pressure through the siphon.

8. The sprayer of claim 7 wherein an inner pocket is defined in the lid by a top wall and an outer circumferential wall, a through hole is formed through the top wall, the valve stem is fitted in the through hole, with a valve rib gripping the top wall.

9. The sprayer of claim 8 wherein the lid further comprises a gripping portion for manually turning the lid, the valve stem positioned beneath the gripping portion.

10. The sprayer of claim 9 wherein a recess is formed in the top portion opposite the inner pocket, with the top wall dividing the recess and the inner pocket.

11. The sprayer of claim 10 wherein the valve stem is positioned substantially beneath a top rim of the recess.

12. A lid for attachment to a threaded opening of a pressure vessel, the pressure vessel having an outer wall, a bottom wall, an interior defined by the outer wall and the bottom wall, and a spray nozzle at a terminus of a hose that is connected through the outer wall to a siphon, with the threaded opening opposite the bottom wall for pouring liquids through, the lid being configured for temporary attachment to the chuck of an external compressor, the lid comprising:
a valve stem extending from a top portion and externally from the interior of the pressure vessel and configured to receive an air chuck of a compressor, the valve stem extending through a center of the lid along a cylindrical axis of the lid;
a threaded engagement portion for attaching the lid to the threaded opening;
an annular shoulder for compressing an annular gasket against a sealing surface of the threaded opening; and
a gripping portion for manually turning the lid, the valve stem being positioned beneath the gripping portion;
wherein the liquid is poured through the threaded opening to partially fill the interior of the pressure vessel, and the lid is attached to the threaded opening to hermetically seal the lid to the threaded opening by compression of the annular gasket;
and wherein the chuck of the compressor is connected to the valve stem and pressurized gas is introduced through the valve stem from the compressor to pressurize the interior;
and wherein opening the spray nozzle permits the liquid to be forced out of the interior under pressure through the siphon.

13. The lid of claim 12 wherein an inner pocket is defined in the lid by a top wall and an outer circumferential wall, a through hole is formed through the top wall, the valve stem is fitted in the through hole, with a valve rib gripping the top wall.

14. The lid of claim 13 wherein a recess is formed in the top portion opposite the inner pocket, with the top wall dividing the recess and the inner pocket.

15. The lid of claim 14 wherein the valve stem is positioned substantially beneath a top rim of the recess.
